(19) United States
(12) Patent Application Publication
(10) Pub. No.: US 2014/0181546 A1
(43) Pub. Date: Jun. 26, 2014

(54) METHOD AND APPARATUS FOR POWER RESOURCE PROTECTION

(71) Applicants: ALAN D. HALLBERG, North Plains, OR (US); JORGE P. RODRIGUEZ, PORTLAND, OR (US); PHILIP R. LEHWALDER, Hillsboro, OR (US); PATRICK K. LEUNG, Hillsboro, OR (US); ALEXANDER B. UAN-ZO-LI, Hillsboro, OR (US); RUOYING MA, Portland, OR (US); JEFFREY A. CARLSON, Hillsboro, OR (US)

(72) Inventors: ALAN D. HALLBERG, North Plains, OR (US); JORGE P. RODRIGUEZ, PORTLAND, OR (US); PHILIP R. LEHWALDER, Hillsboro, OR (US); PATRICK K. LEUNG, Hillsboro, OR (US); ALEXANDER B. UAN-ZO-LI, Hillsboro, OR (US); RUOYING MA, Portland, OR (US); JEFFREY A. CARLSON, Hillsboro, OR (US)

(21) Appl. No.: 13/726,338

(22) Filed: Dec. 24, 2012

(51) Int. Cl. G06F 1/32; H02H 9/02

(52) U.S. Cl. CPC G06F 1/3234; H02H 9/02; G06F 1/3206
USPC 713/320; 361/87

(57) ABSTRACT

An apparatus may comprise a platform power protection circuit to monitor an electric current over a platform input line, the electric current received on the platform input line from a current source, and output an alert signal from a comparator when current output is determined to exceed a current threshold. The apparatus may further include logic to assert a control signal to reduce power consumption in one or more platform components coupled to the platform input line when the alert signal is received. Other embodiments are disclosed and claimed.

### BACKGROUND

In present day electronic computing and communications platforms, input power source (e.g., battery or AC adapter) protection is lacking. While the need for such protection may have been less important in previous generations of such platforms, present day components such as a general processor (CPU) and graphics processor may have design features that allow high power performance that exceeds the thermal design of a platform that incorporates such components. One such feature is a dynamic overclocking feature, sometimes referred to as “turbo boost” or “turbo mode” that enables a processor to operate above its base operating frequency. Typically, a series of performance states may be defined in a configuration specification, and the turbo mode may be activated when an operating system requests the highest performance state of the given processor.

The excursion into high power or turbo mode may result in platform input voltage droop, and may cause an alternating current (AC) adapter or power supply under-voltage or/over-current shut down, inadvertent data loss, and/or platform failure.

However, because such high performance processors are more widely deployed in present day platforms, it may be desirable to accommodate such devices without at the same time placing undue risk of platform failure. For example, although a scenario such as the operation of multiple processors at a highest turbo power mode may risk overcurrent/undervoltage conditions that induce platform failure, such conditions may occur only occasionally, such that it is desirable to supply a platform having such processors using an AC adapter that may not be rated to supply power at the highest possible level in which the processor can run. Moreover, the maximum amount of current drawn by a platform may be hard to predict especially when multiple components may be potentially active and operating in different power modes at any given time. Accordingly, an unpredicted but infrequent power surge may occur that exceeds the ability of an AC adapter to safely drive.

It is with respect to these and other considerations that the present improvements have been needed.

### BRIEF DESCRIPTION OF THE DRAWINGS

FIG. 1 depicts one embodiment of a system that provides platform input power protection.

FIG. 2 illustrates another embodiment of a platform power protection system.

FIG. 3 details the control of current output in one scenario consistent with the present embodiments.

FIG. 4 depicts an exemplary voltage curve that may be output under the scenario depicted in FIG. 3.

FIG. 5 shows an exemplary curve for current output that may represent the current drawn from an AC adapter.

FIG. 6 depicts an exemplary signal level that may be generated in response to the detected output current of FIG. 5.

FIG. 7 depicts an exemplary control signal that may be generated in response to the detected output current of FIG. 5.

FIG. 8 depicts an exemplary voltage curve that may be output under the scenario depicted in FIG. 5 to FIG. 7.

FIG. 9 depicts an exemplary first logic flow.

FIG. 10 depicts an exemplary second logic flow.

FIG. 11 is a diagram of an exemplary system embodiment.

FIG. 12 depicts a further exemplary system embodiment

### DETAILED DESCRIPTION

Various embodiments may comprise one or more elements. An element may comprise any structure arranged to perform certain operations. Some elements may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Various embodiments are related to managing platform power including computing devices, portable communications devices, communications devices, and other electronics devices. In various embodiments, apparatus and techniques are provided that better manage current supplied to a platform. In particular, the present embodiments address, among other things, the problem of overcurrent voltage droop that may occur due to increased current drawn by platform components from an AC adapter/power supply.

In accordance with some embodiments, the current output from an AC adapter/power supply is monitored and dynamically altered in a manner that may prevent inadvertent shutdown of a system, platform failure, and/or data loss. Other embodiments are described and claimed.

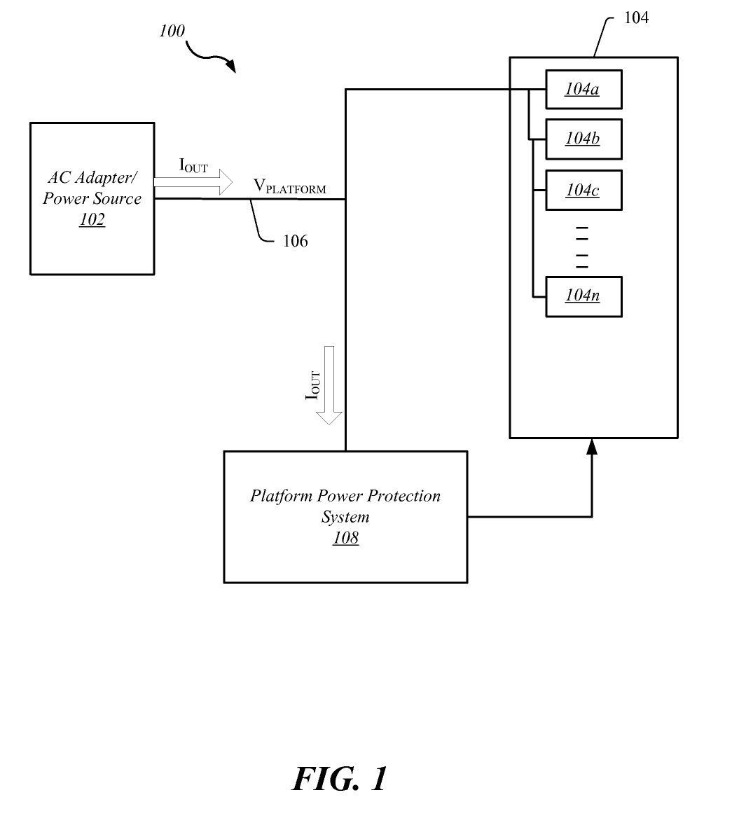

FIG. 1 depicts one embodiment of a system 100 that provides platform input power protection for the platform 104. As illustrated, the system 100 may include an AC adapter/power source (also termed herein “AC adapter”) 102 that supplies power through a platform input line 106 to platform 104 (shown individually as components 104a to 114n, where a, b, c, d, and n represent any non-zero positive integer, and need not represent the same integer). The platform input line 106 may supply power at a nominal voltage range as specified for the platform 104. In various modes, the system 100 may operate while coupled to external AC voltage via the AC power supply 102. In some embodiments, the system 100 may also be powered by a battery (not shown).

Platform components 104 may include one or more voltage regulators that are designed to operate within a specific input voltage tolerance or range. Accordingly, if the system input voltage 106 is below the specific input voltage range, the system 100 may not function properly or may shut down. As noted above, modern processor design allows for high power (“turbo”) operation of such platform components 104. These power excursions may result in short periods in which power consumption may cause a concomitant drop in system input voltage 106 to below safe operating levels, even if the time average input voltage is above a lower limit for safe operation of the platform components 104. Even without operation in such turbo modes, the processor power may increase due to increased workload such that voltage droop occurs. In one example, one or more of components 104a to 104n may be operative to adjust its mode to a high power mode for short periods of time in order to provide enhanced performance. These periods may typically last several milliseconds to tens of milliseconds and may take place occasionally, such as at instances that are separated from one another by hundreds of milliseconds or seconds. In this manner, the platform device(s) may operate at a regular power level, or regular operating mode, for a majority of the time, while operating in high power modes for short durations. Depending upon the magnitude of the power increase in a high power mode, the current output I_{OUT} that is output from the AC adapter 102 may surge and the system input voltage, shown as V_{PLATFORM} may droop below an acceptable level, such that operation of platform components is threatened or platform shutdown occurs.

To prevent such adverse circumstances, system 100 includes a platform power protection system 108 that is operative to monitor the current output I_{OUT} that is output from the AC adapter 102, and to respond in order to limit current surges so that overcurrent/undervoltage conditions are limited to prevent inadvertent shutdown, data loss, or other adverse effects. In various embodiments, the platform power protection system 108 may be implemented in hardware, or a combination of hardware and software, examples of which are detailed with respect to the FIGS. to follow. For example, when the AC adapter is plugged into an external AC power line, the AC adapter may be rated for a maximum current output of 4.5 A. During proper operation, the output current I_{OUT} from the AC adapter may range up to 4.5 A depending upon the requirements of the platform devices at any given time. Consistent with the present embodiments, the platform power protection system 108 may be set to detect when I_{OUT} is excessive, and to generate a control signal that alters the operation of one or more platform components to reduce I_{OUT} which may result in preventing or stopping potentially damaging input voltage droop. In the above example, if the I_{OUT} from the AC adapter 102 were detected to exceed 4.5 A or another current limit set to ensure proper operation, the platform power protection system may rapidly generate a control signal to reduce power consumed in the one or more platform components 104a to 104n. This reduction in power consumed by platform 104, in turn, may result in lowering the I_{OUT} from the AC adapter 102 before any damaging events take place.

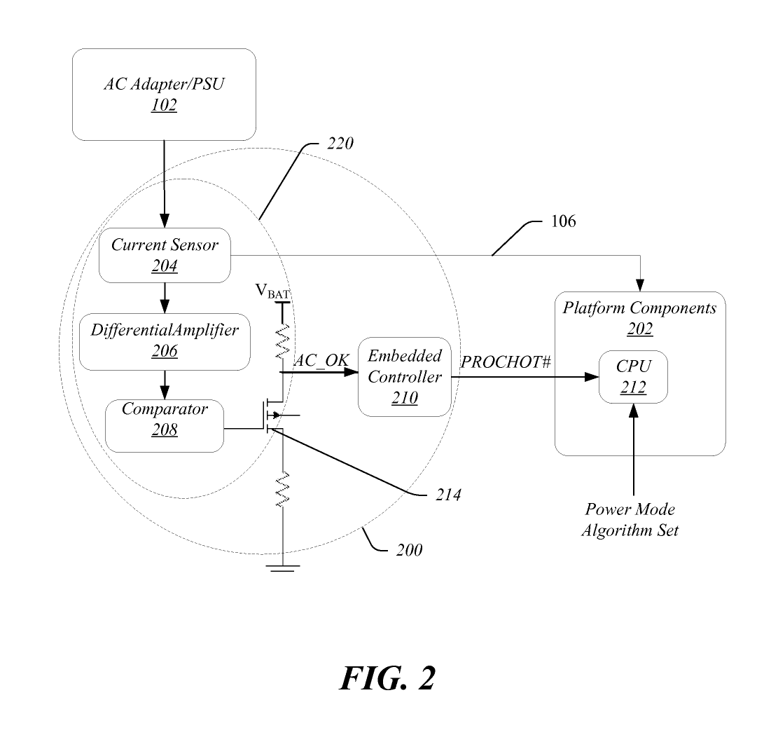

FIG. 2 illustrates one embodiment of a platform power protection system 200. In this embodiment, the platform power protection system 200 is arranged to monitor the current output by the AC adapter 102. As illustrated, the AC adapter 102 may couple to platform components 202 (not shown as individual components save for CPU 212) via the platform input line 106. The platform power protection system 200 is also coupled to the AC adapter 102 to monitor current that is conducted to platform components 202 over the platform input line 106.

In the embodiment of FIG. 2, the platform power protection system 200 includes a platform power protection circuit 220 that contains a current sensor 204, differential amplifier 206, and comparator 208. The platform power protection system 200 also includes an embedded controller 210. The platform power protection system 200 is generally operative to output a control signal under specific circumstances that may cause one or more of the platform components 202 to reduce operating power.

In operation, to provide power to the platform components 202 the AC adapter 102 may be coupled to a source of external AC power (not shown) and to the system input line 106. The system input line 106 may power an entire platform (not separately shown) such as a computer that includes the platform components 202, and may further include the platform power protection system 200. Notably, although not explicitly shown in FIG. 2, one or more components of the platform power protection system 200 may be considered as part of the platform components 202.

When one or more of platform components 202 are active, power may be drawn from the AC adapter 102 such that the current output I_{OUT} from the AC adapter 102 varies according to the level of power consumed by the collection of platform components 202 that are active at any given time. To illustrate operation of the platform power protection system 200, in one example, it may be assumed that the AC adapter 102 is rated to 65 W, while a CPU 212 may be operative to consume up to 90 W power. If the CPU enters a turbo operation mode in which power approaches the 90 W limit, the initial current drawn from the AC adapter 102 may exceed safe operation limits. In this circumstance the platform power protection system 200 may detect the excessive current and generate a signal to place the CPU 212 in a lower power mode so that the current drawn from AC adapter 102 reduces to safe levels.

In particular, the current sensor 204 may monitor the current output I_{OUT} from the AC adapter 102, and provide a current signal to the differential amplifier 206. The differential amplifier 206 may then generate an amplified current signal that is received at the comparator 208. Consistent with the present embodiments, the comparator 208 may be set to output a signal when the amplified current signal exceeds a reference value. In one example, the comparator 208 may have a first input (not shown) that receives a reference value characteristic of the current limit for current output I_{OUT} from the AC adapter 102. In one instance, the current limit of the reference value may be set to indicate 4.5 A following the above example. The comparator 208 may include a second input to receive the amplified current signal. When the amplified current signal received at the second input of comparator 208 indicates a value of current output I_{OUT} from the AC adapter 102 in excess of 4.5 A, the comparator 208 may output a signal to the gate of a field effect transistor (or, simply “transistor) 214. In the example shown the field effect transistor is a P-type field effect transistor (pFET).

When the voltage level set by the signal output by comparator 208 is received at the gate of the transistor 214, the transistor may turn on, such that an alert signal is generated. In the example of FIG. 2, the alert signal is an “AC_OK signal. In conventional operation, the AC_OK signal is a binary signal whose voltage level indicates the level of an AC signal. For example, during operation where the AC signal is within a normal operating range, the AC_OK signal may be low, while when the AC signal is above the normal range, the AC_OK signal level is high, that is, the AC_OK signal is asserted. As further shown in FIG. 2 and consistent with the present embodiments, the embedded controller 210 may be operative to detect the assertion of an AC_OK signal. For example, an interrupt of the embedded controller 210 may be set to detect a high AC_OK signal. In this instance, the receipt of the AC_OK signal may trigger the embedded controller 210 to output a control signal in response that is used to control operation of platform components 202, such as CPU 212.

In various embodiments, the control signal that is output by embedded controller 210 may be operative to reduce power in one or more platform components 202 until the control signal is de-asserted. In the example of FIG. 2, the embedded controller 210 may generate a PROCHOT# signal that is transmitted to the CPU 212 in response to receiving the AC_OK signal. In particular, the control PROCHOT# signal may be asserted over a PROCHOT# pin. The PROCHOT# pin is a type of package pin that is typically employed in conventional systems to signal excessive heat of components, such as one or more of the platform components 202. In conventional use, if any processor core reaches a temperature higher than a predetermined threshold, the PROCHOT# will assert which will trigger a thermal control circuit to active and remain active until the thermal breach ends, after which PROCHOT# deasserts. Accordingly, in the present embodiments, a PROCHOT# pin may be employed to convey both control signals to respond to an overcurrent condition in the AC adapter 102 as well as control signals to respond to overheating of platform components. For example, in a scenario in which overheating of one or more platform components is detected, the PROCHOT# may assert over the PROCHOT number pin to trigger lowering power for a duration until the components cool to an appropriate level. On the other hand, if an excess current event from the AC adapter 102 is detected, the signal carried over PROCHOT# pin may trigger one or more platform components to lower power for a duration sufficient to bring current below a threshold. In the latter scenario, in some instances the duration of such an overcurrent event may be much shorter than for an overheating event.

Continuing with FIG. 2, upon receiving a PROCHOT# signal, the CPU 212 may adjust its operation such as by reducing power in a high power mode, such as a turbo mode. The CPU 212 may also reduce its operating frequency, by, for example, entering a so-called low frequency mode. In any of these actions, the current consumed by the CPU 212 may be reduced. Because typical CPU processors may perform such actions on a time scale of less than one millisecond, for example, about 100 microseconds, overall current consumption by the platform components 202, including CPU 212, may be reduced rapidly in response to a detected overcurrent condition where I_{OUT} is excessive. In this manner, shutdown of AC adapter 102 may be avoided as well as failure of the platform containing platform components 202.

Thus, embodiments consistent with the arrangement of FIG. 2 provide the advantages that existing signal protocol may be harnessed to provide overcurrent/undervoltage protection to a platform. In particular, the AC_OK and PROCHOT# signals that are employed in conventional apparatus for other purposes may be exploited to direct power reduction in a timely fashion without the use of additional new signaling. This may minimize any additional costs to implement as well as avoiding increased complexity in firmware that may be installed on a component such as an embedded controller.

However, as will be readily appreciated by those of skill in the art, the present embodiments are not limited to the specific arrangement shown in FIG. 2, since other circuits or logic may be readily envisioned that act in a similar fashion to manage the assertion of a control signal in response to a detection of excessive current from the AC adapter 102.

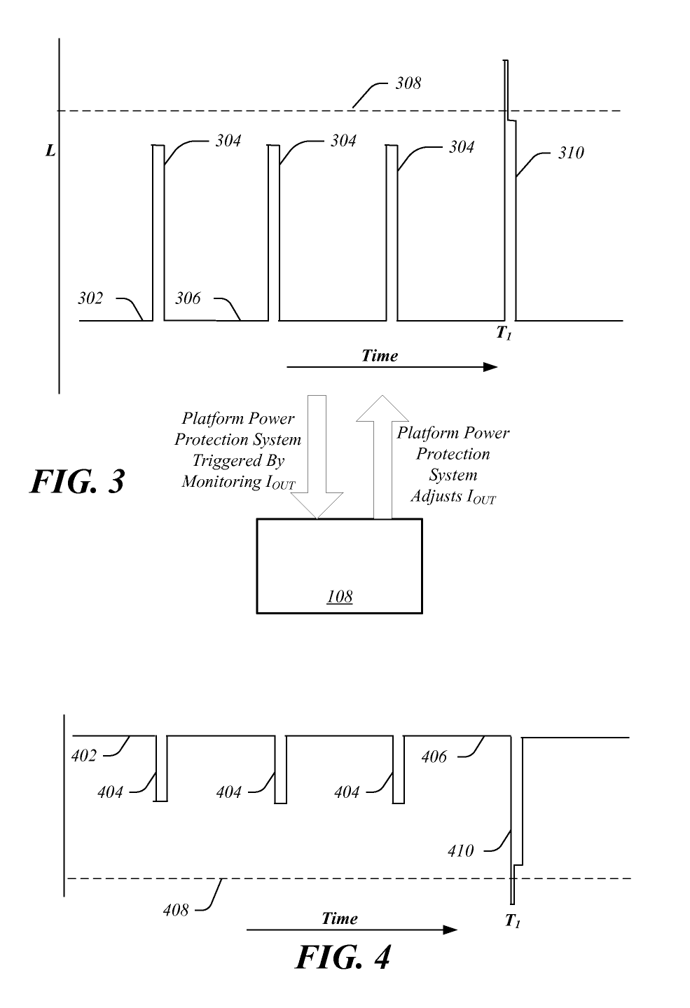

FIG. 3 details the control of current output from an AC adapter in one scenario that is consistent with the present embodiments. In FIG. 3 there is shown an exemplary curve for the current output I_{OUT} 302 that may be output, for example, from the AC adapter 102 as a function of time. As suggested in FIG. 3, the platform power protection system 108 may be interoperable in a feedback manner with the current output I_{OUT} 302 such that action by the platform power protection system 108 is triggered by the monitoring of current output I_{OUT} 302 while the platform power protection system 108 in turn causes adjustment to current output I_{OUT} 302.

In particular, in FIG. 3 the curve for current output I_{OUT} 302 may represent a scenario in which a platform component such as a CPU 212 increases its current consumption on multiple occasions. As shown in FIG. 3, the current output I_{OUT} 302 exhibits several peak portions 304 in which current levels are higher than in a baseline portion 306. In particular, the level of current output I_{OUT} 302 in baseline portions 306 may represent the total current drawn by all platform components including that drawn by the CPU 212 while operating in normal power mode. For simplicity, it may be assumed that the peak portions 304 represent the incremental increase in current drawn when the CPU 212 enters a high power mode. Thus, it may be assumed that on average, other platform components contribute no net change in peak current as a function of time. It may also be observed that the duration of each peak portion 304 may be relatively short, for example on the order of tens or hundreds of milliseconds.

Consistent with the present embodiments, the platform power control system 108 may set a current limit 308, as shown in FIG. 3. If current output I_{OUT} 302 exceeds the current limit 308, the platform power protection system 108, 210 may be triggered into action as described above with respect to FIG. 1 and FIG. 2. As shown, the series of peak portions 304 exhibit a maximum current level denoted by L, whose value is below that of the current limit 310. Accordingly in the interval up to the time T₁ the platform power control system 108 is not triggered to perform any action even though multiple current excursions denoted by the peak portions 304 occur. However, at the time T₁ there is generated a current peak portion 310, whose current level exceeds the current limit 308. This may arise, for example, when a CPU 212 enters a highest power mode. When the current level exceeds current limit 308 at time T₁ the platform current protection system 108 may be triggered to generate a control signal that results in reducing current consumption by the CPU 212. Because the CPU 212 may respond rapidly to such a control signal, this results in a rapid drop of the overall current output I_{OUT} 302. As shown in FIG. 3 the level of the peak portion 310 drops immediately after the time T₁ to a value that is below the current threshold 308.

As noted previously, one factor in determining the value to set for the current threshold 308 is the voltage threshold for stable operation of a platform. Because excessive current draw from an AC adapter may engender a droop in input voltage to a platform, the current threshold 308 may be set to avoid or minimize the voltage droop below a critical value in an input line connected to that AC adapter. FIG. 4 depicts an exemplary voltage curve 402 that may be output by an AC adapter under the scenario depicted in FIG. 3 for current output I_{OUT} 302. As shown in FIG. 4, the voltage curve 402 exhibits a series of voltage peaks 404 that are downwardly projecting from baseline portions 406, indicating a decrease in voltage output by the AC adapter. The voltage peaks 404 coincide with the current peak portions 304 of FIG. 3. Thus, whenever a current surge from the AC adapter occurs, a concomitant droop in voltage output by the AC adapter may also occur. In the example of FIG. 4, a voltage threshold 408 is illustrated, which may indicate a threshold below which platform operation is adversely affected, such as possible shutdown. As shown, the current surges shown by current peak portions 304 do not induce a voltage droop that breaks the voltage threshold 408. However, the current peak portion 306 does result in the voltage peak 410 breaching the voltage threshold 408. However, because the level of current is rapidly adjusted downwardly by the response of the platform power control system 108, the voltage level is raised rapidly above the voltage threshold 408, which may ensure that platform shutdown or data loss does not occur.

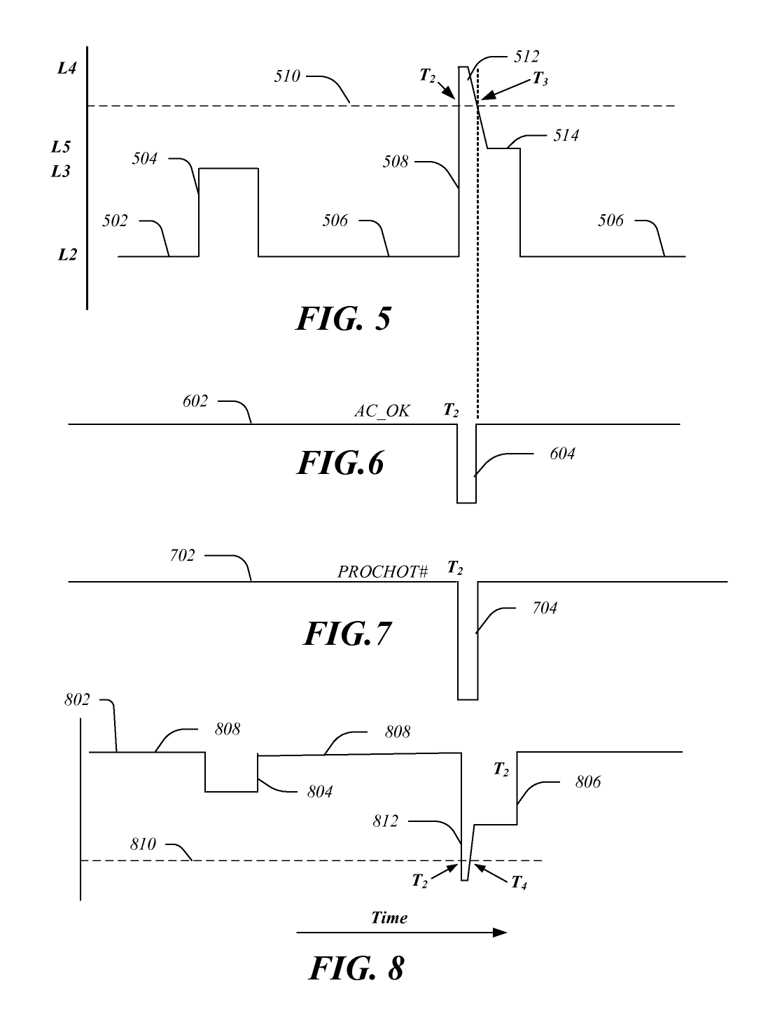

FIGS. 5 to 8 provide further details of signal timing that illustrate one scenario for platform power protection consistent with the present embodiments. In each of FIGS. 5 to 8 the parameter time is plotted along the abscissa, as indicated in FIG. 8. FIG. 5 shows an exemplary curve for current output I_{OUT} 502 that may represent the current drawn from the AC adapter 102 when one or more of platform components 104 are active. For the majority of the time, the value of current output I_{OUT} 502 is at the level L2, which is illustrated by baseline portions 506. A first current peak 504 whose current value reaches the level L3 may represent an increase in current output I_{OUT} 502 that occurs when the CPU 212 transitions from a normal power mode to a high power mode for a duration indicated by the width of the first current peak 504. For simplicity, it may be assumed that the first current peak 504 represents the incremental increase in current drawn by the CPU 212 when it enters the high power mode. Thus, it may be assumed that on average, other platform components contribute no net change in peak current as a function of time.

FIG. 5 also depicts a second current peak 508 that occurs subsequent to first current peak 504. In the example shown, the current level in the second current peak 508 exceeds that of the first current peak 504. The second current peak 508 may represent, for example the incremental increase in current drawn by CPU 212 when it enters a highest power turbo mode. As illustrated, in the narrow peak portion 512 the second current peak 508 reaches a current level L4 that exceeds the value of the current threshold 510 indicated by the horizontal dashed line. In particular at the time T₂ the current in the second current peak 508 exceeds the current threshold 510 as illustrated in FIG. 5. At this time, the platform power protection circuit 108 may detect that the present current level exceeds the preset current threshold value, thereby triggering the assertion of an AC_OK signal as illustrated above with respect to FIG. 2 and discussed further below with respect to FIG. 6.

As also explained previously, the platform power protection circuit 108 may further respond to an alert signal by generating a control signal to cause the CPU 212 to lower its operating power. This response engenders a drop in CPU power consumed and thereby a drop in the current level of second current peak 508, as illustrated. In the particular example of FIG. 5, the current level reaches a value L5 in the lower peak portion 514 that is less than current threshold 510, but is higher than that of the L3 or L2. Thus, in this example, the CPU 212 may remain in an elevated power mode so long as the level of current output I_{OUT} 502 remains below current threshold 510.

FIG. 6 depicts an exemplary signal level of an AC_OK signal 602 that may be generated in response to the detected output current I_{OUT} 502 of FIG. 5. Referring also once more to FIG. 2, it is to be noted that the platform power protection component may be arranged so that the AC_OK signal 602 is asserted for the duration that the amplified detected current signal exceeds the preset threshold value. Accordingly, in the scenario of FIGS. 5 and 6, a shown by the peak 604, the AC_OK signal 602 is asserted for the duration between time T₂ and the time T₃ at which current level of current output I_{OUT} 502 drops below the current threshold 510.

When the AC_OK signal 602 is asserted, the AC_OK signal 602 may trigger the generation of the PROCHOT# signal as discussed previously in regards to FIG. 2. FIG. 7 depicts an exemplary PROCHOT# signal 702 that may be asserted in response to the detected output current I_{OUT} 502 of FIG. 5 and the assertion of the AC_OK signal 602. In the example of FIG. 7, the PROCHOT# signal 702 is asserted at approximately time T₂ as shown by the peak 704. In accordance with the present embodiments, a controller such as the embedded controller 210 may assert the PROCHOT# signal 702 long enough for platform components to reduce their operating power to acceptable levels. Thus, in the example of FIG. 7, the PROCHOT# signal 702 may be asserted for a duration similar to that of AC_OK signal 602, that is, until the time T₃ at which the output current I_{OUT} 502 shown in FIG. 5 decreases below the current threshold 510.

As a consequence of the operation of the embodiment shown in the scenario of FIGS. 5 to 7, the voltage output to the platform by an AC adapter may be maintained at acceptable levels. FIG. 8 depicts an exemplary voltage curve 802 that may be output by an AC adapter under the scenario depicted in FIG. 5 to FIG. 7 for current output I_{OUT} 502. As shown in FIG. 8, the voltage curve 802 exhibits a series of voltage peaks 804, 806 that are downwardly projecting from baseline portions 808, indicating a decrease in voltage output by the AC adapter, or platform input voltage. These voltage peaks 804, 806 correspond to the respective current peaks 504, 508 shown in FIG. 5. It is to be noted that not all surges in current drawn from an AC adapter may induce a concomitant decrease in voltage from the AC adapter. In particular, in many conditions in which total power drawn from the AC adapter is within normal operating range, the voltage output from the AC adapter may not be strongly affected by changes in current output. However, when the current surge corresponds to a power level that may be close to the power rating of the AC adapter or above the power rating, the voltage output may exhibit significant droop. As noted previously with respect to FIG. 4, when this droop causes voltage to fall below a threshold value, the safe operation of a platform may be jeopardized.

To address this, the present embodiments provide a rapid mechanism to reduce processor or other platform component current as soon as the monitored AC current, such as output current I_{OUT} 502 of FIG. 5 meets or exceeds a current threshold. In some embodiments, the value of the current threshold, such as current threshold 510, may at least in part be determined based upon a corresponding voltage output by an AC adapter for that given current threshold. Thus, in the scenario shown in FIGS. 5 to 8, the reduction of output current I_{OUT} 502 below a current threshold 510 may also bring the voltage level of voltage curve 802 above a voltage threshold 810. The voltage threshold 810 may represent is some examples a voltage below which operation of one or more platform components may be unstable. As detailed in FIG. 8, the voltage level of the initial portion 812 of voltage peak 806 falls below the voltage threshold 810. Because this circumstance may jeopardize platform operation, it is useful that the duration that the voltage level of voltage curve 802 remains below the threshold voltage 510 be minimized. In the scenario of FIG. 5 to FIG. 8, the rapid reduction in output current I_{OUT} 502 after time T₂ as shown in FIG. 5 results in a rapid rise in the voltage level of voltage curve 802 such that the voltage level exceeds the voltage threshold 810 after the time T₄. In various examples, the duration between time T₂ and T₄ may be about a few milliseconds, and in some cases less than one millisecond. It may be seen therefore, that by rapidly responding to a detected overcurrent condition based upon measured output current from an AC adapter, the present embodiments may also provide for minimizing the time in which voltage drawn by the platform is below an acceptable range.

It is to be emphasized that consistent with the various embodiments the platform components giving rise to a detected current surge need not be those whose power is adjusted in response. In other words, the surge in activity of a first platform component may give rise to excessive current drawn from an AC adapter. In response, the platform power protection system 108 may generate a control signal that reduces power in one or more platform components that may include other components than the first platform component.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

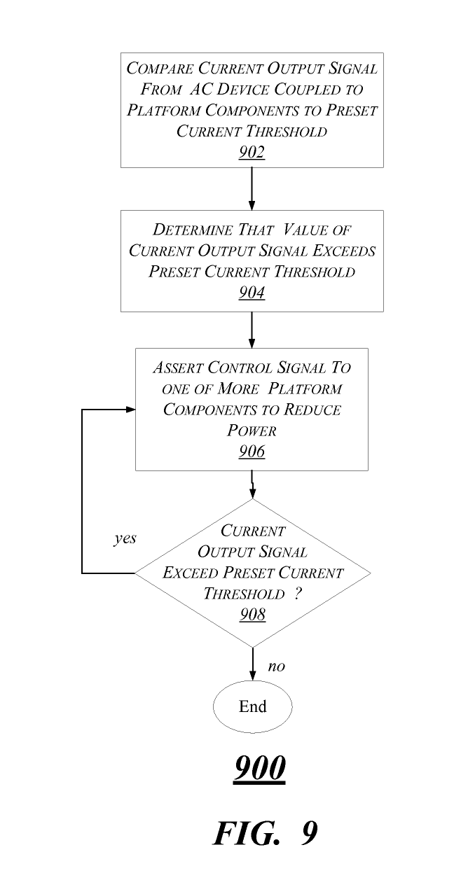

FIG. 9 depicts an exemplary first logic flow 900. At block 902, the current output signal from an AC device coupled to platform components is compared to a present threshold. In one instance the AC device is an AC adapter.

At block 904, it is determined that the value of the current output signal exceeds a preset current threshold. The preset current threshold may correspond to a current limit for safe operation of the platform components.

At block 906, a control signal is asserted to one or more platform components to reduce power. In one example, the control signal is a PROCHOT# signal that is sent to one or more CPU processors/processor cores and/or one or more graphics processors/processor cores.

At decision block 908 a determination is made as to whether the current output signal continues to exceed the preset current threshold. If so, the process returns to block 906. If not, the process ends.

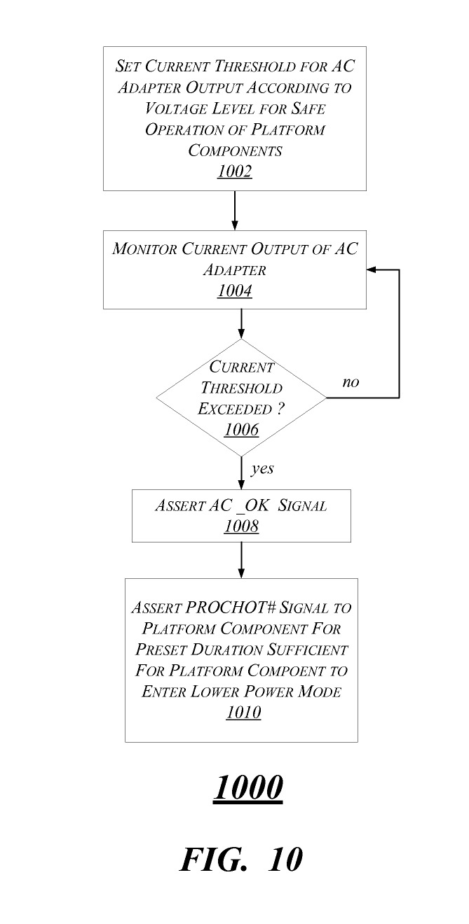

FIG. 10 depicts an exemplary second logic flow 1000. The logic flow 1000 may be implemented, for example, by a platform power protection system.

At block 1002 a current threshold is set for AC adapter output current according to a safe voltage level for operation of platform components.

At block 1004 the current output of the AC adapter is monitored. The logic flow then proceeds to block 1006.

At decision block 1006, a determination is made as to whether the current limit exceeded. If, at block 1006, a determination is made that the current limit is not exceeded, the logic flow returns to block 1004, where the current output of the AC adapter continues to be monitored.

If, at block 1006, a determination is made that the current limit is exceeded, the logic flow proceeds to block 1008. At block 1008, an AC_OK signal is asserted. The flow then proceeds to block 1010.

At block 1010, a PROCHOT# signal is asserted to a platform component for preset duration sufficient for that platform component to enter a low power mode of operation.

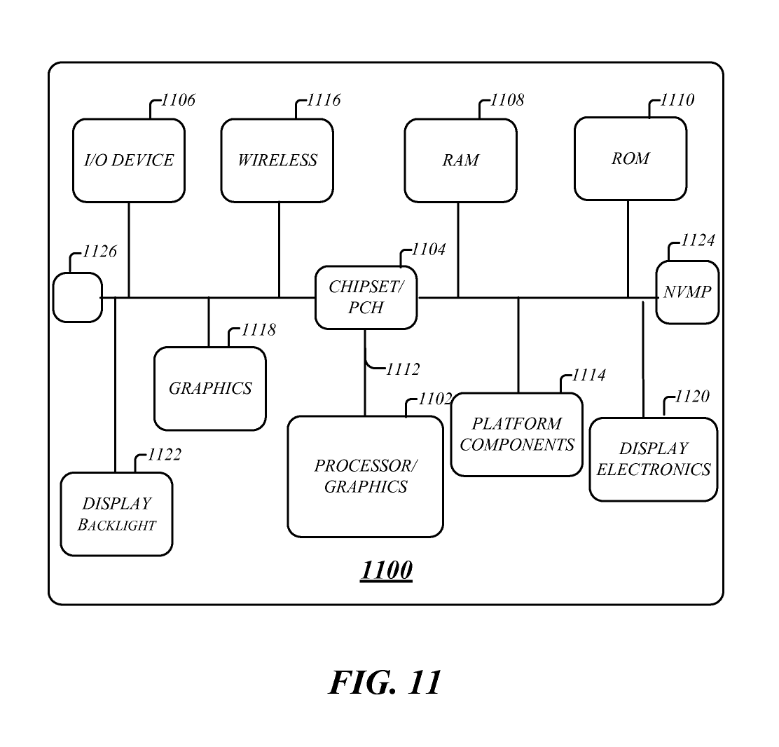

FIG. 11 is a diagram of an exemplary system embodiment and in particular, FIG. 11 is a diagram showing a platform 1100, which may include various elements. For instance, FIG. 11 shows that platform (system) 1110 may include a processor/graphics core 1102, a chipset/platform control hub (PCH) 1104, an input/output (I/O) device 1106, a random access memory (RAM) (such as dynamic RAM (DRAM)) 1108, and a read only memory (ROM) 1110, display electronics 1120, display backlight 1122, and various other platform components 1114 (e.g., a fan, a crossflow blower, a heat sink, DTM system, cooling system, housing, vents, and so forth). System 1100 may also include wireless communications chip 1116 and graphics device 1118. The embodiments, however, are not limited to these elements.

As shown in FIG. 11, I/O device 1106, RAM 1108, and ROM 1110 are coupled to processor 1102 by way of chipset 1104. Chipset 1104 may be coupled to processor 1102 by a bus 1112. Accordingly, bus 1112 may include multiple lines.

Processor 1102 may be a central processing unit comprising one or more processor cores and may include any number of processors having any number of processor cores. The processor 1102 may include any type of processing unit, such as, for example, CPU, multi-processing unit, a reduced instruction set computer (RISC), a processor that have a pipeline, a complex instruction set computer (CISC), digital signal processor (DSP), and so forth. In some embodiments, processor 1102 may be multiple separate processors located on separate integrated circuit chips. In some embodiments processor 1102 may be a processor having integrated graphics, while in other embodiments processor 1102 may be a graphics core or cores.

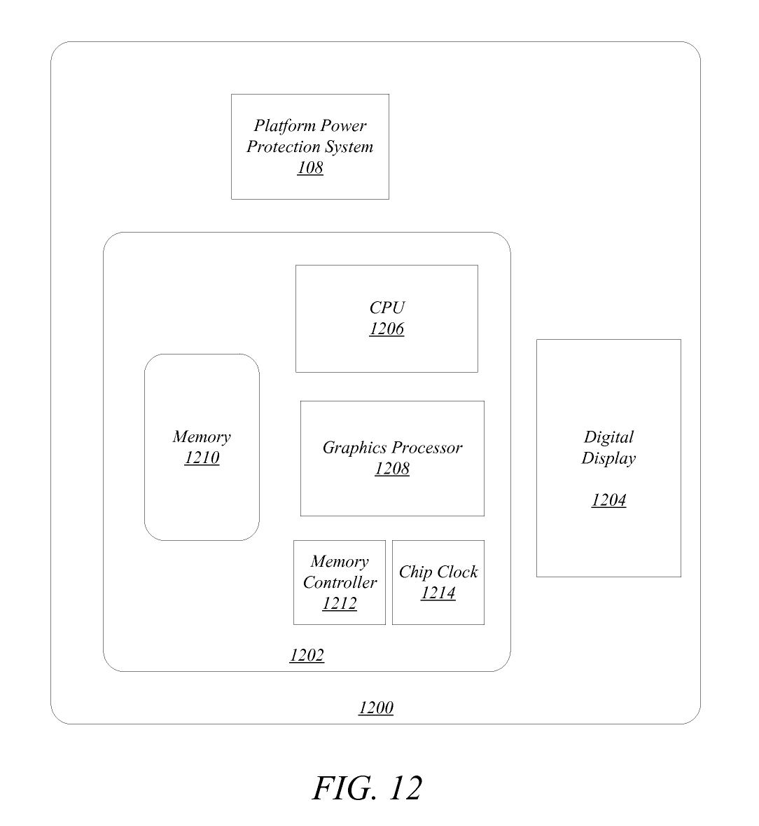

FIG. 12 depicts one embodiment of a system 1200, which may include the platform power protection system 108 and various other elements. The system 1200 may be implemented in various devices including cellular telephones, tablet computing devices, smartphones, set-top devices, notebook computers, electronic games, and other devices. The embodiments are not limited in this contest. The system 1200 may include a system-on-a-chip (SoC) 1202 and digital display 1204. As further shown in FIG. 12, the SoC 1202 includes, in addition to a CPU 1206 and graphics processor 1208, a memory 1210, memory controller 1212 and chip clock 1214.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

In one embodiment, an apparatus may include a platform power protection circuit to monitor an electric current over a platform input line, the electric current received on the platform input line from a current source, and to output an alert signal from a comparator when current output is determined to exceed a current threshold. The apparatus may further include logic to assert a control signal to reduce power consumption in one or more platform components coupled to the platform input line when the alert signal is received.

In another embodiment, wherein the control signal may cause a reduction of an operating frequency of a processor, the processor comprising one of the platform components

Alternatively, or in addition, in a further embodiment, the platform power protection circuit may generate a binary signal indicative of AC signal level when monitored AC current is determined to exceed the current threshold.

Alternatively, or in addition, in a further embodiment the platform power protection circuit may include a current sensor to sample current, a differential amplifier to produce an amplified current signal from the sampled current, and a comparator to output the alert signal when the amplified current signal exceeds an input value corresponding to the current threshold.

Alternatively, or in addition, in a further embodiment the apparatus may include an embedded controller to set an interrupt to detect the alert signal, and to assert the control signal when the interrupt is triggered.

Alternatively, or in addition, in a further embodiment the logic may assert the control signal to reduce platform component power for a preset duration sufficient for the one or more platform components to enter a low power mode of operation.

Alternatively, or in addition, in a further embodiment the logic may assert the control signal when the monitored current exceeds the current threshold.

Alternatively, or in addition, in a further embodiment, the current source may include an alternating current (AC) adapter.

In another embodiment, a computer implemented method may include monitoring an electric current over a platform input line, the electric current received on the platform input line from a current source, outputting an alert signal when current output is determined to exceed a current threshold, and asserting a control signal to reduce power consumption in one or more platform components coupled to the platform input line when the alert signal is generated.

In a further embodiment, the computer implemented method may include asserting a control signal to lower processor operating frequency.

Alternatively, or in addition, in a further embodiment, the computer implemented method may include generating the alert signal as a binary signal indicative of AC signal level when monitored AC current is determined to exceed the current threshold.

Alternatively, or in addition, in a further embodiment, the computer implemented method may include sampling AC current in the platform input line, producing an amplified current signal from the sampled current, and outputting the alert when the amplified current signal exceeds an input value corresponding to the current threshold.

Alternatively, or in addition, in a further embodiment, the computer implemented method may include setting an interrupt to detect the alert signal, and asserting the control signal when the interrupt is triggered.

Alternatively, or in addition, in a further embodiment, computer implemented the method may include asserting the control signal to reduce platform component power for a preset duration sufficient for the one or more platform components to enter a low power mode of operation.

Alternatively, or in addition, in a further embodiment the computer implemented method may include asserting the control signal when the monitored current exceeds the current threshold.

In a further embodiment, an apparatus may be configured to perform the method of any one of the preceding embodiments.

In another embodiment, at least one machine readable medium may comprise a plurality of instructions that in response to being executed on a computing device, cause the computing device to carry out a method according to any one of the preceding embodiments.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a computer-readable medium or article which may store an instruction or a set of instructions that, if executed by a computer, may cause the computer to perform a method and/or operations in accordance with the embodiments. Such a computer may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments

1. An apparatus, comprising:
a platform power protection circuit to:
monitor an electric current over a platform input line, the electric current received on the platform input line from a current source; and
output an alert signal from a comparator when current output is determined to exceed a current threshold; and
logic to assert a control signal to reduce power consumption in one or more platform components coupled to the platform input line when the alert signal is received.

2. The apparatus of claim 1, wherein the control signal to cause a reduction of an operating frequency of a processor, the processor comprising one of the platform components.

3. The apparatus of claim 1, the platform power protection circuit to generate a binary signal indicative of AC signal level when monitored AC current is determined to exceed the current threshold.

4. The apparatus of claim 1, the platform power protection circuit comprising:
a current sensor to sample current;
a differential amplifier to produce an amplified current signal from the sampled current; and
a comparator to output the alert signal when the amplified current signal exceeds an input value corresponding to the current threshold.

5. The apparatus of claim 3, comprising an embedded controller to:
set an interrupt to detect the alert signal; and
assert the control signal when the interrupt is triggered.

6. The apparatus of claim 1, wherein the logic to assert the control signal for a preset duration sufficient for the one or more platform components to enter a low power mode of operation.

7. The apparatus of claim 1, the logic to assert the control signal when the monitored current exceeds the current threshold.

8. The apparatus of claim 1, wherein the current source comprises an alternating current (AC) adapter.

9. A computer implemented method, comprising:
monitoring an electric current over a platform input line, the electric current received on the platform input line from a current source;
outputting an alert signal when current output is determined to exceed a current threshold; and
asserting a control signal to reduce power consumption in one or more platform components coupled to the platform input line when the alert signal is generated.

10. The computer implemented method of claim 9, comprising asserting a control signal to lower processor operating frequency.

11. The computer implemented method of claim 9, comprising generating the alert signal as a binary signal indicative of AC signal level when monitored AC current is determined to exceed the current threshold.

12. The computer implemented method of claim 9, comprising:
sampling AC current in the platform input line;
producing an amplified current signal from the sampled current; and
outputting the alert when the amplified current signal exceeds an input value corresponding to the current threshold.

13. The computer implemented method of claim 11, comprising:
setting an interrupt to detect the alert signal; and
asserting the control signal when the interrupt is triggered.

14. The computer implemented method of claim 9, the comprising asserting the control signal to reduce platform component power for a preset duration sufficient for the one or more platform components to enter a low power mode of operation.

15. The computer implemented method of claim 9, comprising asserting the control signal when the monitored current exceeds the current threshold.

16. At least one computer-readable storage medium comprising a plurality of instructions that, when executed, cause a system to:
receive an alert signal indicative of a current threshold breach for current in a platform input line; and
cause assertion of a control signal to reduce power consumption in one or more platform components coupled to the platform input line when the alert signal is received.

17. The at least one computer-readable storage medium of claim 16 comprising instructions that, when executed, cause a system to cause assertion of the control signal to induce a reduction of processor operation frequency.

18. The at least one computer-readable storage medium of claim 16 comprising instructions that, when executed, cause a system to generate the alert signal as an binary signal indicative of AC signal level when monitored AC current is determined to exceed the current threshold.

19. The at least one computer-readable storage medium of claim 18 comprising instructions that, when executed, cause a system to generate signals to:
set an interrupt to detect the alert signal; and
assert the control signal when the interrupt is triggered.

20. The at least one computer-readable storage medium of claim 16 comprising instructions that, when executed, cause a system to generate signals to assert the control signal to reduce platform component power for a preset duration sufficient for the one or more platform components to enter a low power mode of operation.

21. The at least one computer-readable storage medium of claim 16 comprising instructions that, when executed, cause a system to generate signals to assert the control signal when the monitored current exceeds the current threshold.
